(19) United States
(12) Patent Application Publication
(10) Pub. No.: US 2006/0032401 A1
(43) Pub. Date: Feb. 16, 2006

(54) Colorant compositions

(76) Inventor: Mohammed Kamruzzaman, Monmouth Junction, NJ (US)

Correspondence Address: THOMAS E. SPATH, ESQ.;ABELMAN, FRAYNE & SCHWAB, 150 East 42nd Street, New York, NY, 10017, US

(21) Appl. No.: 10/919,924

(22) Filed: Aug. 16, 2004

(51) Int. Cl. C04B 14/00; C09C 1/44

(52) U.S. Cl. 106/401; 106/476

(57) ABSTRACT

Colorant compositions suitable for industrial coating applications include an aldehyde-ketone resin, distilled tall oil, a non-aqueous solvent, a surfactant and an organic or inorganic pigment.

### FIELD OF THE INVENTION

This invention is directed to an improved pigment dispersion and, more particularly, to a pigment dispersion that is compatible with a large number of paint systems and which enhances the adhesion properties of the coatings in which it is incorporated and also significantly improves intercoat adhesion.

### BACKGROUND OF THE INVENTION

Pigment dispersions or colorants are well-known to the art. They are also well-known in the paint industry since they are the color components of paint formulations. Pigments containing color are used in surface coatings and which provide color and hiding power. While dry pigments can be ground into the paint formulations, paint manufacturers prefer to employ liquid pigment dispersions. The advantages and benefits to be realized by using liquid pigment dispersions are easy handling, choice of colors and cost savings.

The pigment dispersions must be compatible with various paint systems and should not affect any of the physical properties of the liquid paint and the dried films.

Architectural paints, for example, are relatively simple and, therefore, so are the architectural colorants. By contrast, industrial coatings are much more complex, as is their underlying chemistry. While most industrial coatings are two-part systems, there are a significant number which are three-part systems. It has been found that industrial coatings require good heat, ultraviolet and chemical resistance properties, as well as the need to provide a pleasing and aesthetic appearance. Since as stated previously industrial coatings are relatively complex, it has been found that pigment dispersions often suffer from incompatibility, which frequently serves to adversely affect the physical properties of the finished coating.

Another important factor in preparing industrial colorants is their significant expense when compared to architectural colorants. Thus, the industry has been challenged to provide pigment dispersions which are compatible with large numbers of paint systems and which will not adversely affect the physical properties of the coatings while, at the same time, achieving a satisfactory result in a cost-effective manner.

### SUMMARY OF THE INVENTION

A pigment dispersion composition has now been found which can be advantageously utilized in a variety of industrial coating systems and which has improved adhesion properties with respect to both the basecoat and the inter-coat. In addition to the pigment, the dispersion composition comprises a ketone-aldehyde resin, a distilled tall oil, one or more non-aqueous solvents and one or more surfactants. Optionally, the pigment dispersion can also include an anti-settling agent.

It has been found that the use of tall oil in the composition enhances the van der Waals' forces that produce improved binding and, therefore, improved bonding or adhesion of the cured composition to the substrate to which the composition is applied. The ketone-adelhyde resin provides hydrogen binding sites with respect to the substrate.

Pigment dispersions or colorant formulations in accordance with the present invention contemplate in one embodiment thereof from about 5% to about 75%, by weight, of a pigment, about 1% to about 30%, by weight, of a ketone-aldehyde resin, from about 1% to about 15%, by weight, of a distilled tall oil, from about 10% to about 80%, by weight, of a solvent or a mixture of solvents and from about 0.1% to about 10%, by weight, of one or more surfactants. Optionally, the formulation includes about 0.1% to about 5%, by weight, of an anti-settling agent.

Highly concentrated pigment dispersions can be prepared in accordance with the present invention. These dispersions contain relatively high proportions of pigment, but stil have a viscosity value that allows for ease of handling.

### DETAILED DESCRIPTION OF THE INVENTION

In a preferred embodiment of the present invention, the pigment content of the dispersion is about 10% to about 70%, by weight; the ketone-aldehyde resin content is about 3% to about 15%, by weight; the distilled tall oil content is about 2% to about 10%, by weight; and the solvent content is about 15% to about 60%, by weight, and from about 1% to about 6%, by weight, of surfactant is present. Optionally, an anti-settling compound is included. It is preferred that it be from about 0.1% to about 2%, by weight.

The ketone-aldehyde resins which can be used in the present invention are those which are soluble or dilutable in non-aqueous solvents. Exemplary of such ketone-aldehyde resins are Laropal® from BASF, Krumbhaar™ from Eastman Chemical and Synthetic Resin from Degussa Corporation. It has also been found advantageous if the ketone-aldehyde resins of the present invention possesses a glass transition temperature (Tg) of between about 52 and about 62° C.

The solvents which can be employed in the practice of the present invention include aliphatic and oxygenated non-aqueous carrier solvents, as well as mixtures thereof. Exemplary of such solvents are mineral spirits and propylene glycol monomethyl ether acetate.

While a variety of tall oils may be employed to advantage in the present invention, it is especially preferred to utilize distilled tall oils containing from about 10% to about 40%, by weight, of rosin. Among such tall oils are Westvaco® from Mead Westvaco Corporation, Sylvatal® from Arizona Chemical, PAMAK® from Eastman Chemical, and XTOL® from Georgia Pacific Corp.

Various anti-settling additives can be used in the practice of the present invention, exemplary of which are fumed-silica and organoclays. Such additives serve to provide an improved pigment suspension property which is especially important when heavy inorganic pigments are employed in the dispersion.

In accordance with the present invention, highly concentrated pigment dispersions can readily be prepared. Notwithstanding that these dispersions contain very high loadings of pigments, which can be either organic or inorganic in nature, they must also possess a reasonable viscosity level which provides for ease of handling. A variety of pigments may be employed which include, but are not limited to, the following: carbon black, quinacridones, toluidine reds, phthalocyanine green, phthalocyanine blue, Yellow Iron Oxide, Red Iron Oxide, Pigment Yellow 74, Pigment Red 170, titanium dioxide, zinc oxides, chromium oxides, zinc and cadmium sulfides, cadmium selenides and ultramarine blue.

Among the surface active agents which can be employed, although not limited thereto, are nonoxynol-9-phosphate, soya lecithin and mixtures thereof.

The non-aqueous dispersion of the present invention should have a Stormer viscosity of from about 70 to about 110 Kreb units (KU), and preferably from about 85 to about 95 Kreb units, when applied as either a base coat or an intercoat in an industrial coating in order to achieve ease of application when dispersions with high loadings of pigment are employed, while simultaneously promoting high adhesion levels.

The pigment dispersions of the present invention can be used in non-aqueous industrial coating systems as the color components have been found to have a high level of compatibility, possess very good adhesive properties, as well as superior physical properties in general. Thus, they can be used in a wide variety of industrial paint or colorant systems, including, for example, those which are based upon acrylic, alkyd, epoxy, and polyurethane chemistry. The results obtained in the examples set forth below demonstrate broad compatibility, improved adhesion (with both base coat and intercoat), and either minimal negative effects or a complete lack of negative effects, with respect to other physical properties.

### PREPARATIVE EXAMPLE

The method by which the pigment dispersions of the present invention have been prepared involves the use of standard dispersing and milling equipment. The process consists of two main steps.

In the first step, which involves the preparation of a pre-mix, a high-speed disperser is employed. The mixing time is about 30 minutes and the speed employed is 3,000 rpms.

The second step in the preparation of the pigment dispersion is referred to as the milling of the premix. In this step, the premix is milled for a period of twenty minutes in a Chicago Boiler bead mill which is set at a Hegman grind of 7.

When certain inorganic pigment dispersions are prepared, for example, the titanium dioxide dispersion of Example 8, discussed below, only a high-speed disperser was used since milling was not required.

### Example 1

Highly concentrated pigment dispersions can be prepared in accordance with the present invention. These dispersions contain relatively high proportions of pigment, but still have a viscosity value that allows for ease of handling.

In this example, a 35% carbon black loading was employed, which is a high loading of pigment when compared to currently available commercial pigment dispersions that contain, for example, only 10-20% pigment. A highly concentrated pigment dispersion means lesser quantities are needed to achieve the requisite color. Added benefits are manufacturing efficiencies, low shipping volume, a reduced need for inventory and cost savings to the manufacturer and user.

The quantities set forth in the examples are expressed as percentages by weight, unless otherwise indicated.

In this example and the remaining examples, the aldehyde-ketone resin employed was Laropal® by BASF and the distilled tall oil was Westvaco® by Mead-Westvaco.

| | |
|---|---|
| Aldehyde-Ketone resin | 8.0 |
| Distilled Tall Oil | 4.5 |
| Soya Lecithin | 4.0 |
| Nonoxynol-9-Phosphate | 0.4 |
| Mineral Spirits | 48.1 |
| Carbon Black | 35.0 |

The measured Stormer viscosity was 70 KU.

Pigment dispersions containing low levels of resin and surfactants can be prepared in accordance with the present invention which leads to less expensive products. Example 1 is representative of such a product where only 5.2% of resin solid was employed, which is very low considering that 35.0% by weight of carbon black was employed as the pigment.

### Example 2

| | |
|---|---|
| Aldehyde-Ketone resin | 12.0 |
| Distilled Tall Oil | 4.5 |
| Soya Lecithin | 4.0 |
| Nonoxynol-9-Phosphate | 0.5 |
| Mineral Spirits | 30.0 |
| Propylene Glycol Monomethyl Ether Acetate | 24.0 |
| Phthalocyanine Green | 25.0 |

The measured Stormer viscosity was 95 KU.

### Example 3

| | |
|---|---|
| Aldehyde-Ketone resin | 12.0 |
| Distilled Tall Oil | 4.5 |
| Soya Lecithin | 4.0 |
| Nonoxynol-9-Phosphate | 0.5 |
| Mineral Spirits | 54.0 |
| Phthalocyanine Blue | 25.0 |

The measured Stormer viscosity was 82 KU.

### Example 4

| | |
|---|---|
| Aldehyde-Ketone resin | 8.0 |
| Distilled Tall Oil | 4.5 |
| Soya Lecithin | 4.0 |
| Nonoxynol-9-Phosphate | 0.5 |
| Mineral Spirits | 27.0 |
| Yellow Iron Oxide | 55.0 |
| Fumed Silica | 1.0 |

The measured Stormer viscosity was 93 KU.

### Example 5

| | |
|---|---|
| Aldehyde-Ketone resin | 8.0 |
| Distilled Tall Oil | 4.5 |
| Soya Lecithin | 4.0 |
| Nonoxynol-9-Phosphate | 0.5 |
| Mineral Spirits | 22.5 |
| Red Iron Oxide | 60.0 |
| Organoclay | 0.5 |

The measured Stormer viscosity was 85 KU.

### Example 6

| | |
|---|---|
| Aldehyde-Ketone resin | 8.0 |
| Distilled Tall Oil | 4.0 |
| Soya Lecithin | 4.0 |
| Nonoxynol-9-Phosphate | 0.5 |
| Mineral Spirits | 26.0 |
| Propylene Glycol Monomethyl Ether Acetate | 31.5 |
| Pigment Yellow 74 | 26.0 |

The measured Stormer viscosity was 100 KU.

### Example 7

| | |
|---|---|
| Aldehyde-Ketone resin | 14.0 |
| Distilled Tall Oil | 4.5 |
| Soya Lecithin | 4.0 |
| Nonoxynol-9-Phosphate | 0.5 |
| Mineral Spirits | 40.0 |
| Propylene Glycol Monomethyl Ether Acetate | 7.0 |
| Pigment Red 170 | 30.0 |

The measured Stormer viscosity was 70 KU.

### Example 8

| | |
|---|---|
| Aldehyde-Ketone resin | 5.5 |
| Distilled Tall Oil | 4.5 |
| Nonoxynol-9-Phosphate | 3.5 |
| Mineral Spirits | 10.0 |
| Propylene Glycol Monomethyl Ether Acetate | 6.5 |
| Titanium Dioxide | 70.0 |

The measured Stormer viscosity was 75 KU.

Each of the colorant dispersions prepared in accordance with the foregoing examples were added to and mixed with a polyurethane-based surface coating composition and applied to a metal substrate. The test panels were subjected to a standard test for measuring adhesion by tape test pursuant to ASTM D-3359-97, Test Method B (Cross Cut Tape Test).

When the specimen test panels coated with compositions containing colorants of Examples 1-8 were subjected to the Cross-Cut Test set forth in ASTM D-3359, all of the specimens prepared in accordance with the present invention achieved a 5B rating, the highest possible rating. A 5B rating signifies that the edges of the cuts are completely smooth and none of the squares in the lattice is detached.

By contrast, specimens coated with compositions containing four (4) of the commercially available colorants exhibited the lowest rating, namely 0B (Red, Yellow, Phthalo Green and Black). This is the worst possible rating indicating that flaking and detachment is even worse than grade 1B. Of the four (4) remaining commercially available colorants tested, three (3) were rated 5B (Titanium White, Yellow, and Red Oxide), while one received a 2B rating (Phthalo Blue), denoting that an area comprising from 15% to 35% of the coating was removed, accompanied by significant flaking.

The results are set forth in Table 1 below.

TABLE 1
Adhesion Test Results in a 2K* Polyurethane DTM** System

| | | Colorants In | |
|---|---|---|---|
| | | Accordance with | Cross-Cut |
| Existing Colorants | Cross-Cut Results | Invention | Results |
| Black | 0B | Black | 5B |
| Phthalo Green | 0B | Phthalo Green | 5B |
| Phthalo Blue | 2B | Phthalo Blue | 5B |
| Yellow Oxide | 5B | Yellow Oxide | 5B |
| Red Oxide | 5B | Red Oxide | 5B |
| Yellow | 0B | Yellow | 5B |
| Red | 0B | Red | 5B |
| Titanium White | 5B | Titanium White | 5B |

*Part A - polyester polyol
Part B - polyisocyanate
**DTM - Direct to Metal

### Definitions of Cross-Cut Adhesion Ratings Obtainable on ASTM D 3359-Test Method B

5B: The edges of the cuts are completely smooth; none of the squares of the lattice is detached.

4B: Small flakes of the coating are detached at intersections; less than 5% of the area is affected.

3B: Small flakes of the coating are detached along edges and at intersections of cuts. The area affected is 5 to 15% of the lattice.

2B: The coating has flaked along the edges and on parts of the squares. The area affected is 15 to 35% of the lattice.

1B: The coating has flaked along the edges of cuts in large ribbons and whole squares have detached. The area affected is 35 to 65% of the lattice.

0B: Flaking and detachment worse than grade 1.

The results obtained with each of the colorant dispersions in accordance with the present invention, as can be seen in Table 1, demonstrated the highest achievable adhesion rating, namely, 5B, while commercially available colorants exhibited a wide variation in their performance, with 50% receiving the lowest possible rating.

It will be appreciated by persons skilled in the art that the present invention is not limited to what has been particularly shown and described above. Rather, the scope of the present invention includes both combinations and subcombinations of the various features described above, as well as variations and modifications thereof that are not in the prior art, which would occur to persons skilled in the art upon reading the foregoing description.

What is claimed is:

1. A pigment dispersion, which comprises:
a) a pigment;
b) a distilled tall oil;
c) a ketone-aldehyde resin;
d) a non-aqueous solvent; and
e) a surfactant.

2. The pigment dispersion of claim 1, further including an anti-settling agent.

3. The pigment dispersion of claim 1, wherein the pigment content is about 5% to about 75%, by weight, the distilled tall oil content is about 1% to about 15%, by weight, the ketone-aldehyde resin content is about 1% to about 30%, by weight, the solvent content is about 10% to about 80%, by weight, and the surfactant content is about 0.1% to about 10%, by weight.

4. The pigment dispersion of claim 3, further including about 0.1% to about 5%, by weight, of an anti-settling agent.

5. The pigment dispersion of claim 1, having a viscosity of about 70 to about 110 Kreb units.

6. The pigment dispersion of claim 5, having a viscosity of about 85 to about 95 Kreb units.

7. The pigment dispersion of claim 1, wherein the distilled tall oil contains about 10% to about 40%, by weight, of rosin.

8. The pigment dispersion of claim 1, wherein the ketone-aldehyde resin is soluble or dilutable in a non-aqueous solvent.

9. The pigment dispersion of claim 8, wherein the ketone-aldehyde resin has a glass transition temperature (Tg) of about 52 to about 62° C.

10. The pigment dispersion of claim 1, wherein the pigment is selected from the group consisting of organic and inorganic pigments.

11. The pigment dispersion of claim 10, wherein the pigment is selected from the group consisting of titanium dioxide, phthalocyanine green, phthalocyanine blue, yellow iron oxide, red iron oxide, zinc oxides, chromium oxides, carbon black, zinc sulfide,cadmium sulfide, quinacridines, toluidine reds.

12. The pigment dispersion of claim 1, wherein the solvent is selected from the group consisting of mineral spirits, propylene glycol monomethyl ether acetate, and mixtures thereof.

13. The pigment dispersion of claim 1, wherein the surfactant is selected from the group consisting of nonoxynol-9-phosphate, soya lecithin, and mixtures thereof.

14. An industrial coating composition selected from the group consisting of polyurethane, acrylic, alkyd and epoxy based coatings containing the pigment dispersion of claim 1.

15. An industrial coating composition selected from the group consisting of polyurethane, acrylic, alkyd and epoxy based coatings containing the pigment dispersion of claim 2.

16. An industrial coating composition selected from the group consisting of polyurethane, acrylic, alkyd and epoxy based coatings containing the pigment dispersion of claim 3.

17. An industrial coating composition selected from the group consisting of polyurethane, acrylic, alkyd and epoxy based coatings containing the pigment dispersion of claim 4.

18. An industrial coating composition selected from the group consisting of polyurethane, acrylic, alkyd and epoxy based coatings containing the pigment dispersion of claim 5.

19. An industrial coating composition selected from the group consisting of polyurethane, acrylic, alkyd and epoxy based coatings containing the pigment dispersion of claim 6.

20. An industrial coating composition selected from the group consisting of polyurethane, acrylic, alkyd and epoxy based coatings containing the pigment dispersion of claim 7.
